(19) United States
(12) Patent Application Publication
(10) Pub. No.: US 2008/0235617 A1
(43) Pub. Date: Sep. 25, 2008

(54) SYSTEM AND METHOD FOR SCROLLING DISPLAY SCREEN, MOBILE TERMINAL INCLUDING THE SYSTEM, AND RECORDING MEDIUM STORING PROGRAM FOR EXECUTING THE METHOD

(75) Inventors: Young-sun KIM, Suwon-si (KR); Jae-young LEE, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/856,316

(22) Filed: Sep. 17, 2007

(30) Foreign Application Priority Data
Mar. 22, 2007 (KR) 10-2007-0028240

(51) Int. Cl. G06F 3/048

(52) U.S. Cl. 715/786

(57) ABSTRACT

A system and method for scrolling a display screen, a mobile terminal including the system, and a recording medium storing a program for executing the method. The system includes an input unit which receives input information according to a key input operation, a display unit which displays items grouped according to a predetermined criterion, and a controller which controls the display unit to display selected items by scrolling the grouped items on a group-by-group basis, in response to the received input information. Accordingly, since a group-based scroll operation can be performed by grouping items displayed on a display screen, items can be efficiently searched for without a separate hierarchical screen change in a situation where the size of a display screen is limited, such as when using a mobile communication terminal.

### CROSS-REFERENCE TO RELATED PATENT APPLICATION

This application claims priority from Korean Patent Application No. 10-2007-0028240, filed on Mar. 22, 2007, in the Korean Intellectual Property Office, the disclosure of which is incorporated herein in its entirety by reference.

### BACKGROUND

1. Technical Field

Systems and methods consistent with the present invention relate to scrolling a display screen, a mobile terminal including a system for scrolling a display screen, and a recording medium storing a program for executing a method for scrolling a display screen, and more particularly, to a scroll system that can be employed to efficiently search through a large amount of information by using a user interface displayed on a display screen.

2. Description of the Related Art

In general, since the size of a display screen of mobile terminals, such as cellular phones, Personal Communications service (PCS) phones, Personal Digital Assistants (PDAs), is limited, a hierarchical screen change is needed to search for desired digital content from among a plurality of pieces of digital content stored in such a mobile terminal. However, it is inconvenient to operate input keys several times for the hierarchical screen change, and a search takes a long time.

Another method of searching for digital content has been suggested, in which all items of digital content are listed on a display screen, and desired digital content is searched for by means of scrolling. However, when many pieces of digital content are listed on a display screen, scrolling must be performed item-by-item in order to search for desired digital content.

In Korean Patent Publication No. 632122, there is disclosed a scroll method of adjusting a scroll rate according to a value set in a scroll setting unit when an amount of data of a display unit exceeds a display screen. However, when a user does not know a position of an item to be searched for from among items listed on a screen, if a scroll rate is too fast, the user may not find the item. Thus, it is difficult to adjust a scroll rate properly.

### SUMMARY OF THE INVENTION

An aspect of the present invention provide a scroll system and scroll method for searching for an item without a separate hierarchical screen change by scrolling items grouped according to a predetermined criterion on a group-by-group basis in a situation where the size of a display screen is limited, such as when using a mobile terminal.

An aspect of the present invention also provides a computer readable recording medium storing a computer readable program for executing the scroll method.

An aspect of the present invention also provides a mobile terminal comprising the scroll system.

An aspect of the present invention provides a system for scrolling a display screen, the system comprising: an input unit receiving input information according to a key input operation; a display unit displaying items grouped according to a predetermined criterion; and a controller controlling the display unit to display selected items by scrolling the grouped items on a group-by-group basis, in response to the received input information.

An aspect of the present invention provides a method of scrolling a display screen, the method comprising: displaying items grouped according to a predetermined criterion on the display screen; receiving input information according to a key input operation; and scrolling the display screen on which the grouped items are displayed, on a group-by-group basis according to the received input information.

An aspect of the present invention provides a mobile terminal comprising a scroll apparatus comprising: an input unit receiving input information according to a key input operation; a display unit displaying items grouped according to a predetermined criterion; and a controller controlling the display unit to display selected items by scrolling the grouped items on a group-by-group basis, in response to the received input information.

An aspect of the present invention provides a computer readable recording medium storing a computer readable program for executing the method of scrolling a display screen.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for scrolling a display screen according to an exemplary embodiment of the present invention;

FIG. 2A is a reference diagram of a display screen according to a conventional scroll system, and FIGS. 2B, 2C and 2D are reference diagrams of a display screen displayed by using scroll systems according to exemplary embodiments of the present invention; and

FIG. 3 is a flowchart of a method of scrolling a display screen according to an exemplary embodiment of the present invention.

### DETAILED DESCRIPTION OF THE INVENTION

Hereinafter, a system for scrolling a display screen, a scroll method, and a computer readable recording medium storing a computer readable program for executing the scroll method will be described in detail by explaining exemplary embodiments of the invention with reference to the attached drawings.

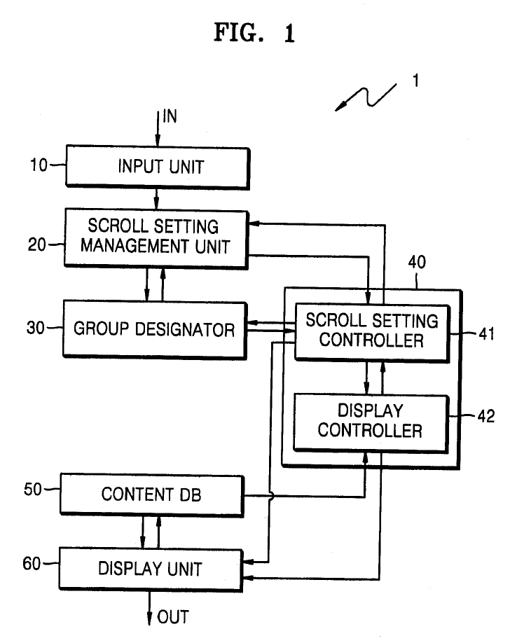

FIG. 1 is a block diagram of a scroll system 1 for scrolling a display screen according to an exemplary embodiment of the present invention. Referring to FIG. 1, the scroll system 1 includes an input unit 10, a scroll setting management unit 20, a group designator 30, a controller 40, a content database (DB) 50, and a display unit 60.

The input unit 10 can receive input information according to an input key operation and store the received information. The input information received by the input unit 10 is information according to a key operation of a user. The information stored in the input unit 10 is transmitted to the scroll setting management unit 20, the group designator 30, and the controller 40. The input unit 10 includes, for example, up, down, left, right buttons, numeral and character input buttons, and a voice input unit employed in a mobile terminal. The input unit 10 may further include a storage member, such as Dynamic Random Access Memory (DRAM) or Static RAM (SRAM), to store the input information.

The input information can include information needed for scroll initialization of a display screen and user scroll operation information input to scroll items displayed on the display screen. The input information can further include virtual grouping attribute information related to a criterion for grouping items and information of a scroll mode. Here, the terminology ‘item’ indicates information regarding content, e.g. a title or an artist name of the content.

The scroll setting management unit 20 stores and manages setting information needed for scrolling based on the input information received by the input unit 10. The scroll setting management unit 20 also determines whether a grouping attribute for grouping items is set and determines whether the scroll mode is a group-based scroll mode or an item-based scroll mode.

The group designator 30 groups items displayed by means of the display unit 60 according to predetermined criterion. The group designator 30 can designate a group suitable for each item as a virtual group using information, which has been input as virtual grouping attribute information, as the criterion for grouping the items. The group designator 30 also can group the items without separate input information for the group designation. For example, in the case of music content, items contain information on a music title and a singer or a performer, and the group designator 30 can set virtual grouping of the items based on a singer or a performer as a default even without separate grouping attribute information. The grouping performed by the group designator 30 according to an exemplary embodiment of the present invention employs the concept of virtual grouping for searching for digital content and displaying an item list of the digital content on a display screen, not the concept of grouping the digital content by means of a separate storage area.

In particular, the group designator 30 can group items stored in the content DB 50 using metadata of digital content. The metadata contains a location and description of content, information on an editor or artist, conditions of rights, conditions of use, a use history, and so on, and the items can be efficiently grouped by using the metadata. The group designator 30 transmits a result of the group designation to the controller 40.

The controller 40 includes a scroll setting controller 41 and a display controller 42. The scroll setting controller 41 controls the display unit 60 to display an input menu associated with scroll setting on a display screen when user input information is needed for settings related to a scroll operation, such as a grouping attribute setting and a scroll mode setting. The display controller 42 controls the display unit 60 to scroll a display screen, on which the items are displayed, on a group-by-group basis according to the input information received by the input unit 10 and display items selected according to the group-based scroll on the display screen.

For example, in a display system in which only a portion of a virtual display image generated to be greater than a display screen is displayed on the display screen, if input information for scrolling the display screen downwards is received by the input unit 10, the scroll setting controller 41 controls an image displayed on the display screen according to determination of the scroll setting management unit 20 on whether scroll setting for a scroll operation has been performed. For example, if a scroll operation signal is input in a state where neither the grouping attribute nor the scroll mode are set, the scroll setting controller 41 transmits a command for displaying the input menu associated with scroll setting on the display screen to the display unit 60 before a scroll operation is performed. If the scroll setting is performed, the display controller 42 transmits a command for displaying a result image according to the input information for the scroll operation to the display unit 60, based on the scroll setting information stored in the scroll setting management unit 20. The scroll system 1 is one of a plurality of systems existing in a mobile terminal in general, and signal processing for the commands can be performed by a processor included in the mobile terminal or by a processor (not shown) included in the scroll system 1.

In particular, in the current exemplary embodiment, the display controller 42 can control the display unit 60 to scroll item by item or group by group. The group-based scroll is the concept extended from conventional scroll for moving items on a display screen. Items must be grouped for the group-based scroll, and virtual grouping using metadata according to each item can be used. Since items can be scrolled on a virtual group-by-virtual group basis according to an operation of the user by means of the virtual grouping, the virtual grouping is convenient to search a great amount of information on a miniaturized display screen.

The content DB 50 stores digital content to be searched using the scroll system 1. Here, the digital content means, for instance, digital information obtained by producing music, characters, codes, sound, or images in a digital manner for use in wired and wireless communication networks. For example, if a specific item is selected by means of the scroll system 1, digital content corresponding to the selected item can be provided to the user in an audio and visual way.

The display unit 60 displays items virtually grouped by the group designator 30. The display unit 60 generates an image greater than the display screen and displays a portion of the generated image, which is selected according to a scroll operation, on the display screen.

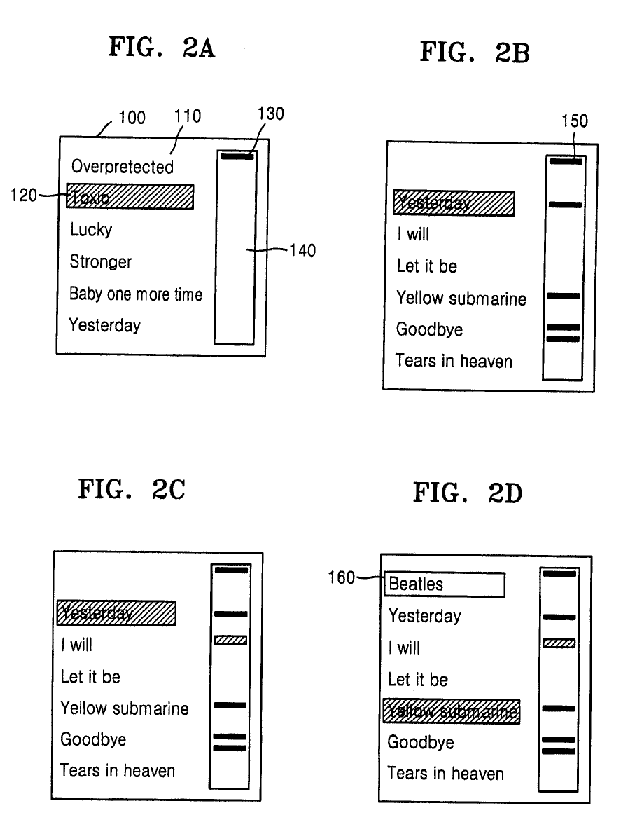

FIGS. 2A, 2B, 2C and 2D are reference diagrams showing examples of a display screen according to various scroll systems employed.

FIG. 2A is a reference diagram of a display screen 100 according to a conventional scroll system. Items displayed in a left region 110 of the display screen 100 are titles of music content. ‘Toxic’ is a currently selected item 120 and is the title of a music content selected by means of a scroll operation. A scroll bar 130 moves upwards and downwards according to a scroll operation. A location of the scroll bar 130 in a scroll bar region 140 reflects a location of the currently selected item 120 among a total of listed items. According to a scroll operation, a location of the scroll bar 130 and an image displayed on the display screen 100 vary.

FIGS. 2B, 2C and 2D are reference diagrams of a display screen produced by a scroll system according to an exemplary embodiment of the present invention.

In FIG. 2B, a mark 150 displayed in a right region of the display screen indicates an artist group, and a scroll bar can move in a unit of the mark 150, i.e. on a group-by-group basis. For example, in FIG. 2B, an artist corresponding to items between a first mark and a second mark is ‘Britney Spears’, and an artist corresponding to items between the second mark and a third mark is ‘Beatles’. Unlike FIG. 2A, a scroll bar in FIG. 2B moves on an artist group-by-artist group basis, and the scroll selected in the current exemplary embodiment can be called, for instance, ‘jump scroll’.

FIG. 2C shows a display screen for selecting an item according to a scroll operation on an item-by-item basis after performing the scroll operation on a group-by-group basis described above. According to the current exemplary embodiment, by selecting an artist of a music file that is to be searched for by means of a scroll operation on a group-by-group basis, and then selecting the music file from among music files of the selected artist by means of a scroll operation on an item-by-item basis, an item can be conveniently searched for without a separate hierarchical change in the display screen. By searching for an item without a separate hierarchical change in the display screen, an item search speed and resource usage efficiency can be improved. If a scroll operation is performed item by item according to the prior art, a search time delay and a problem in a computing resource may occur due to a separate hierarchical change in the display screen. However, according to an exemplary embodiment of the present invention, these problems, and others, can be solved or reduced.

FIG. 2D is a reference diagram showing a group name of a group to which a currently selected item belongs, which is displayed on a display screen according to an exemplary embodiment of the present invention. By further displaying artist information 160 on the display screen, as compared to FIG. 2B or 2C, convenience of a scroll operation can be further improved.

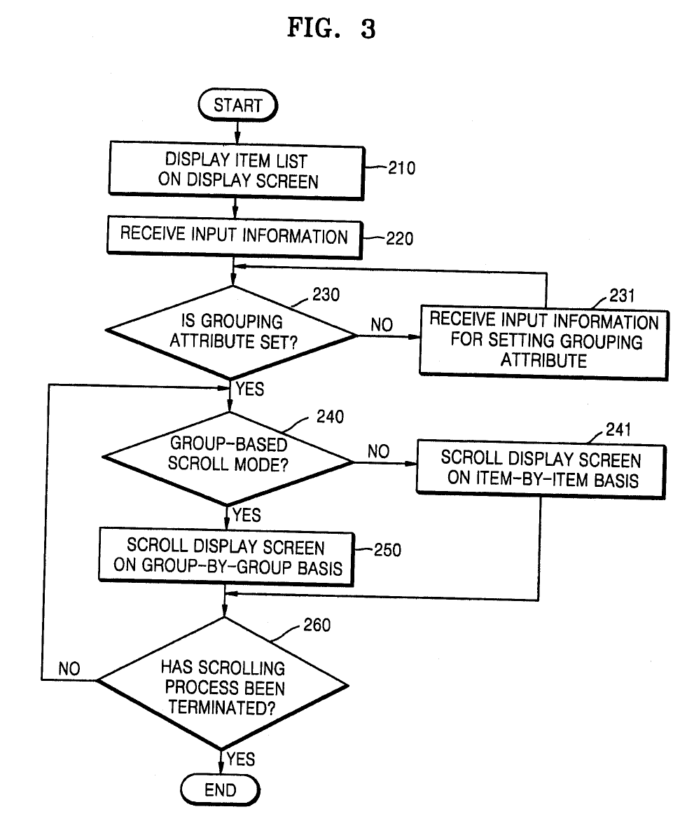

FIG. 3 is a flowchart of a method of scrolling a display screen according to an exemplary embodiment of the present invention. The scroll method according to the current exemplary embodiment of the present invention includes the following operations sequentially performed by the scroll system 1.

Referring to FIG. 3, the display unit 60 displays an item list according to scroll initialization on a display screen in operation 210. For example, when digital content is music and music titles are listed on the display screen as items, it can be configured that titles located from the first among a total of the listed titles are displayed on the display screen in the scroll initialization state. Before displaying the item list on the display screen, a scroll setting process may be further included. Items displayed on the display screen in the scroll setting process may include an item for setting a grouping attribute and an item for setting a scroll mode. If a scroll operation is performed without the scroll setting process, a scroll setting operation can be performed in a subsequent process.

The input unit 10 receives input information according to an input key operation of a user in operation 220. In general, the input information received in operation 220 is scroll operation information for scrolling items displayed on the display screen. Although operation 210 is ahead of operation 220 in the current exemplary embodiment, the execution order of operations 210 and 220 can be changed as required consistent with the present invention. Alternatively, after the scroll initialization for an item search, operation 220 can be omitted to directly perform subsequent operations for determining scroll setting values.

The scroll setting management unit 20 determines in operation 230 whether a grouping attribute is set. If it is determined in operation 230 that the grouping attribute is set, then the controller 40 controls the display unit 60 to perform subsequent operations. If it is determined in operation 230 that the grouping attribute is not set, then the controller 40 controls the display unit 60 to display a menu image for setting the grouping attribute on a display screen before the scroll operation is executed. Thereafter, input information for setting the grouping attribute is received by the input unit 10 in operation 231, and then operation 230 is performed again.

The scroll setting management unit 20 determines in operation 240 whether a currently set scroll mode is a group-based scroll mode. The group-based scroll mode indicates that the scroll operation is performed on a group-by-group basis when a button for the scroll operation is pressed. The item-based scroll mode indicates that the scroll operation is performed on an item-by-item basis.

If it is determined in operation 240 that the currently set scroll mode is the group-based scroll mode, then the controller 40 performs signal control for performing a scroll operation on a group-by-group basis in operation 250. That is, the controller 40 controls the display unit 60 to display a display screen according to group-based scroll, based on input information for the scroll operation from among the input information received in operation 220. The group-based scroll is a concept which extends from general scrolling for moving items on a display screen. It is preferable, but not necessary, in terms of convenience that items can be scrolled or moved on a virtual group-by-virtual group basis according to an operation of the user after forming virtual groups using metadata according to each item for scrolling or moving items on a group-by-group basis.

If it is determined in operation 240 that the currently set scroll mode is not the group-based scroll mode, i.e. that the currently set scroll mode is the item-based scroll mode, then the controller 40 performs signal control for performing a scroll operation on an item-by-item basis in operation 241. The group-based scroll mode or the item-based scroll mode can be selected by the user according to a state. For example, it can be set that a conventional scroll operation is performed by pushing a scroll operation button for a short time and a group scroll operation is performed by pushing the scroll operation button for a long time.

The controller 40 determines in operation 260 whether input information related to termination of the scroll operation has been received and controls the display unit 60 to display different images according to whether the scroll operation is to be continued (i.e., if the process is to return to operation 240) or not.

The method of scrolling a display screen according to an exemplary embodiment of the present invention can be used for a content information search on a display screen. The method of searching for information by means of scroll can include, for example: displaying items virtually grouped according to a predetermined criterion on the display screen; receiving input information according to a key input operation; scrolling the display screen on which the virtually grouped items are displayed on a group-by-group basis according to the received input information; and displaying items specified by means of the group-based scroll on the display screen as a result of the information search.

The method of scrolling a display screen according to an exemplary embodiment of the present invention can also be embodied as computer readable codes on a computer readable recording medium. The computer readable recording medium is any data storage device that can store data which can be thereafter read by a computer system. Examples of such a computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to exemplary embodiments of the present invention, since a group-based scroll operation can be performed by grouping items displayed on a display screen, items can be searched for without a separate hierarchical screen change in a situation where the size of a display screen is limited, such as when using a mobile communication terminal. In addition, since the group-based scroll operation in a scroll system can be performed by means of virtual grouping using metadata of digital content, a great amount of information can be conveniently searched on a miniaturized display screen.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the exemplary embodiments of the invention but by the appended claims, and all differences within the scope will be construed as being included in the present invention.

What is claimed is:

1. A system for scrolling a display screen, the system comprising:
an input unit which receives input information according to a key input operation;
a display unit which displays items which are grouped according to a predetermined criterion; and
a controller which controls the display unit to display selected items by scrolling grouped items on a group-by-group basis, in response to the received input information.

2. The system of claim 1, wherein each of the items comprises information regarding digital content, and
wherein the grouped items are virtually grouped using metadata of the digital content.

3. The system of claim 1, wherein the input information comprises information regarding a grouping attribute related to the predetermined criterion, and
wherein the grouped items are grouped according to the input grouping attribute information.

4. The system of claim 1, wherein the input unit further receives input information for item-based scrolling, and
wherein the controller controls the display unit to display items selected by item-based scrolling, from among the grouped items, according to the further received input information.

5. The system of claim 1, further comprising a group designator which groups the items,
wherein each of the items displayed by the display unit comprises information regarding digital content, and
wherein the grouped items are grouped by the group designator.

6. The system of claim 5, wherein the group designator groups the items using metadata of the digital content.

7. The system of claim 5, wherein each of the items comprises information regarding a title or an artist of digital content.

8. The system of claim 1, wherein an item image displayed by the display unit is a portion of a virtual display image in which all the items are listed, and
wherein the virtual display image is selected according to the input information.

9. The system of claim 1, wherein the input information further comprises scroll mode information, and
wherein the scroll mode information comprises general scroll mode information for item-based scrolling and jump scroll mode information for group-based scrolling.

10. The system of claim 1, wherein the display unit further displays a group name of a group to which items grouped on a group-by-group basis belong.

11. A method of scrolling a display screen, the method comprising:
displaying items which are grouped according to a predetermined criterion on the display screen;
receiving input information according to a key input operation; and
scrolling the display screen on which the grouped items are displayed, on a group-by-group basis, according to the received input information.

12. The method of claim 11, wherein each of the items comprises information regarding digital content, and
wherein the grouped items are grouped using metadata of the digital content.

13. The method of claim 11, wherein the input information comprises information regarding a grouping attribute related to the predetermined criterion, and
wherein the grouped items are grouped according to the received grouping attribute information.

14. The method of claim 11, wherein the receiving input information comprises receiving input information for item-based scrolling, and
wherein the method further comprises scrolling a display screen, on which the grouped items are displayed, on an item-by-item basis according to the received input information for item-based scrolling.

15. The method of claim 11, wherein the items displayed on the display screen are items corresponding to a portion of a virtual display image in which all the items are listed, and
wherein the virtual display image is selected according to the input information.

16. The method of claim 11, wherein the displaying items comprises further displaying a group name of a group to which items grouped on a group-by-group basis belong.

17. A computer readable recording medium storing a computer readable program for executing a method of scrolling a display screen, the method comprising:
displaying items which are grouped according to a predetermined criterion on the display screen;
receiving input information according to a key input operation; and
scrolling the display screen on which the grouped items are displayed, on a group-by-group basis, according to the received input information.

18. A mobile terminal comprising a scroll apparatus, the mobile terminal comprising:
an input unit which receives input information according to a key input operation;
a display unit which displays items which are grouped according to a predetermined criterion; and
a controller which controls the display unit to display selected items by scrolling grouped items on a group-by-group basis, in response to the received input information.
